(19) United States
(12) Patent Application Publication
(10) Pub. No.: US 2008/0124984 A1
(43) Pub. Date: May 29, 2008

(54) LED Lamp Holder

(76) Inventor: Xuliang Li, Dongguan (CN)

Correspondence Address: GLOBAL IP SERVICES, 7285 W. Eagle Court, Winton, CA, 95388, US

(21) Appl. No.: 11/756,831

(22) Filed: Jun. 1, 2007

(30) Foreign Application Priority Data
Nov. 27, 2006 (CN) 200620016039.3

(51) Int. Cl. H01R 24/00

(52) U.S. Cl. 439/699.2

(57) ABSTRACT

This invention relates to a LED lamp holder, and more particularly to a LED lamp holder enabling a LED bulb to be correctly mounted according to its polarity, when using LED lamp strings. A LED lamp holder comprises a soft head having a columnar shape and made of insulated materials, a stopper-shaped soft core made of insulated materials and preassembled with a LED bulb having a long polarity and a short polarity, two connecting plates disposed on ends of two wires, wherein the soft core and the connecting plates are inserted into each other respectively from two ends of the soft head and mounted in the soft head, and two polarities of a LED bulb connect with two connecting plates respectively, wherein the soft core has a high polarity-fixing portion and a low polarity-fixing portion on the end thereof which joins with the connecting plates, the long polarity of LED lamp fixed on the high polarity-fixing portion, and the short polarity of LED lamp on the low polarity-fixing portion; the soft core has a first plane on an outside surface thereof and the soft head has a second plane on an inside surface thereof which corresponds to the first plane of the soft core to limit the circumferential location of the soft core in the soft head; the soft head has a polarity-distinguishing device on the outside thereof. So the invention provides a LED lamp holder which enables a LED bulb to be correctly mounted according to its polarities.

### CROSS REFERENCE TO THE RELATED PATENT APPLICATION

This application claims the priority of the Chinese patent application No. 200620016039.3, filing date of Nov. 27, 2006.

### FIELD OF THE INVENTION

This invention relates to a LED lamp holder, and more particularly to a LED lamp holder enabling a LED bulb to be correctly mounted according to its polarities, when using LED lamp strings.

### BACKGROUND OF THE INVENTION

In modern life, LED lamp strings are often used for decorative lights and have perfectly decorative effect. In prior art, although a LED lamp has a long foot and a short foot both of which have certain polarities, the polarities often are reversely mounted between a LED lamp and a soft core, as well as between the soft core and connecting plates, and between a soft head and the connecting plates because the lamp holder has no polarity-distinguishing device. When a lamp string is long, it will expend much time to check whether polarities of LED bulbs are mounted reversely. When the polarities are badly reversed, the whole string of LED bulbs will even be burnt out.

### SUMMARY OF THE INVENTION

An object of the invention described herein is to provide a LED lamp holder enabling a LED bulb to be correctly mounted according to its polarities for overcoming the defects of prior art.

The object of the invention can be achieved by the following means: A LED lamp holder, comprises a soft head which has a columnar shape and is made of insulated materials, a stopper-shaped soft core which is made of insulated materials and preassembled with a LED bulb having a long polarity and a short polarity, and two connecting plates disposed on ends of two wires, wherein the soft core and the connecting plates are inserted into each other respectively from two ends of the soft head and mounted in the soft head, two polarities of a LED bulb connecting with two connecting plates respectively. Wherein the soft core has a high polarity-fixing portion and a low polarity-fixing portion on the end thereof which joins with the connecting plates, the long polarity of a LED lamp fixed on the high polarity-fixing portion, and the short polarity of a LED lamp fixed on the low polarity-fixing portion; the soft core has a first plane on an outside surface thereof and the soft head has an second plane on an inside surface thereof corresponding to the first plane of the soft core to limit the circumferential location of the soft core in the soft head; a polarity-distinguishing device is formed on the outside of the soft head.

The fitting surface between the soft core and the soft head is a columnar surface, and the first plane and the second plane are respectively formed on the columnar surface of the soft core and the columnar surface of the soft head, both of which are parallel with an axis of the columnar surface.

The polarity-fixing portion has a slot thereon for fixing the polarity.

The polarity-distinguishing device is a plane on the surface of the soft head having a columnar shape, and the two connecting plates are respectively disposed to the right and to the left of the plane.

The LED lamp holder uses a LED bulb having a long foot and a short foot. The long foot and the short foot of LED bulb have certain polarities. Because two polarities of the soft core have the difference of high and low, it enables the high portion and the low portion of the assembly of the LED bulb and the soft core to have certain polarity accordingly when preassembling the LED bulb with the soft core. The soft core and the soft head are fit with each other by the first plane and the second plane so as to avoid polarities of the soft head assembly being erroneously matched. The polarity-distinguishing device is directly disposed on the outside of the soft head so as to enable the polarities of LED bulb coinciding with the polarity-distinguishing device on the outside of the soft head, thus the whole string of LED bulbs can keep correct polarities.

### BRIEF DESCRIPTION OF THE DRAWINGS

FIG. 1 is a perspective view of a LED lamp holder, in accordance with the first example embodiment;

FIG. 2 is an assembled section view of a LED lamp holder, in accordance with the first example embodiment;

FIG. 3 is an exploded view of a LED lamp holder, in accordance with the first example embodiment;

FIG. 4 is a perspective view of strung LED lamp holders, in accordance with the first example embodiment;

FIG. 5 is a perspective view of a soft head, in accordance with the second example embodiment.

### DETAILED DESCRIPTION OF ILLUSTRATED EMBODIMENTS

The invention will further be described in detail accompanied with the figures.

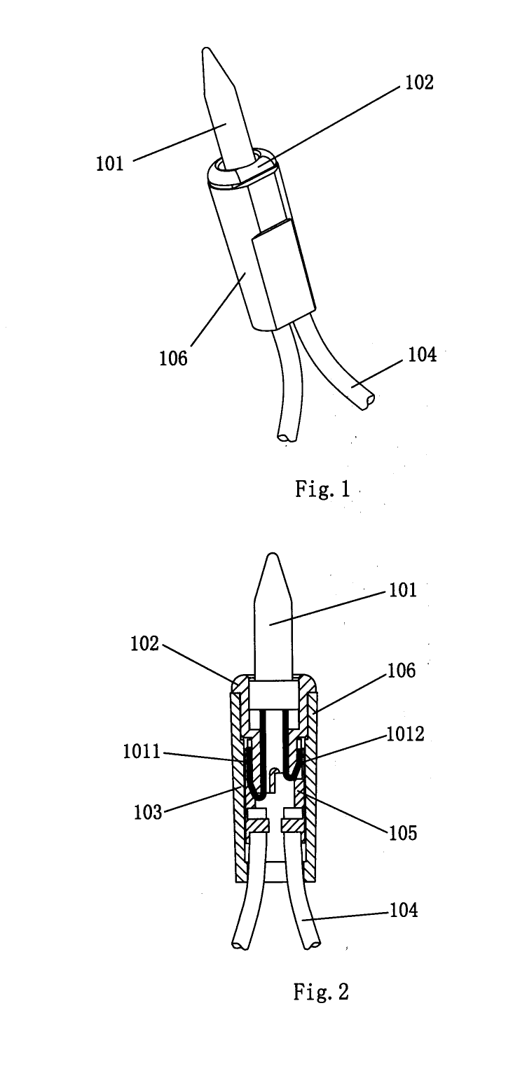

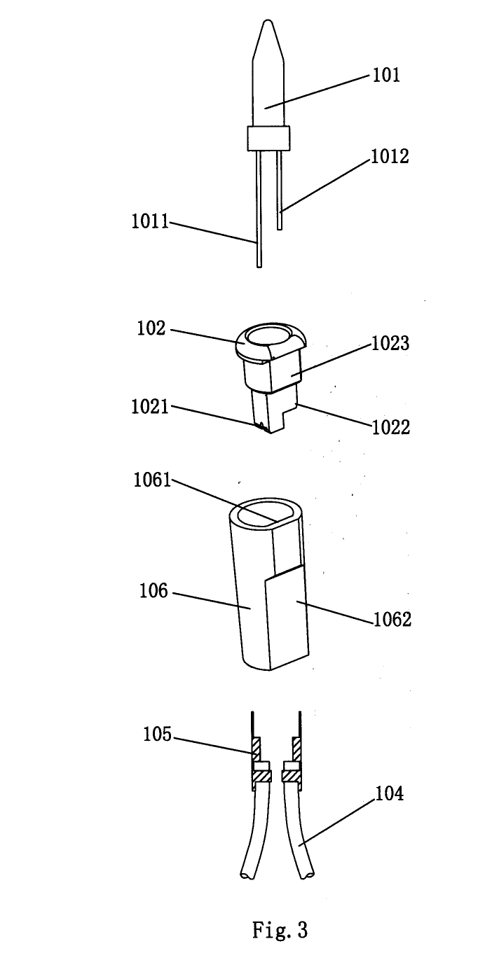

FIGS. 1, 2, 3, and 4 show an example embodiment of the invention.

In the example embodiment, a LED holder comprises a soft head 106 which has a columnar shape and is made of insulated materials, a stopper-shaped soft core 102 which is made of insulated materials and preassembled with a LED bulb 101 having a long polarity and a short polarity, and two connecting plates 105 disposed on ends of two wires 104, wherein the soft core 102 and the connecting plates 105 are inserted into each other respectively from two ends of the soft head 106 and mounted in the soft head 106, two polarities of the LED bulb 101 connecting with two connecting plates 105 respectively. Wherein the soft core 102 has a high polarity-fixing portion and a low polarity-fixing portion on the end thereof which joins with the connecting plates, the long polarity 1011 fixed on the high polarity-fixing portion 1021, and the short polarity 1012 on the low polarity-fixing portion 1022; the soft head 106 has a polarity-distinguishing device 1062 on the outside thereof. The fitting surface between the soft core 102 and the soft head 106 is a columnar surface. A first plane 1023 is formed on the columnar surface of the soft core 102 and a second plane 1061 is formed on the columnar surface of the soft head 106 which corresponds to the first plane 1023 to limit the circumferential location of the soft core 102 in the soft head 106. The first plane 1023 and the second plane 1061 are both parallel with the column axis of the columnar surface. Each of the high polarity-fixing portion 1021 and the low polarity-fixing portion 1022 has a slot thereon for fixing the bulb polarity. The above polarity-distinguishing device is a plane 1062 on the surface of the soft head 106 having a columnar shape, and the two connecting plates are respectively disposed to the right and the left of the plane 1062. In the example embodiment, the short LED polarity 1012 is shorter, and it can not be mounted because of absence of its length if it is disposed in the location of the long polarity.

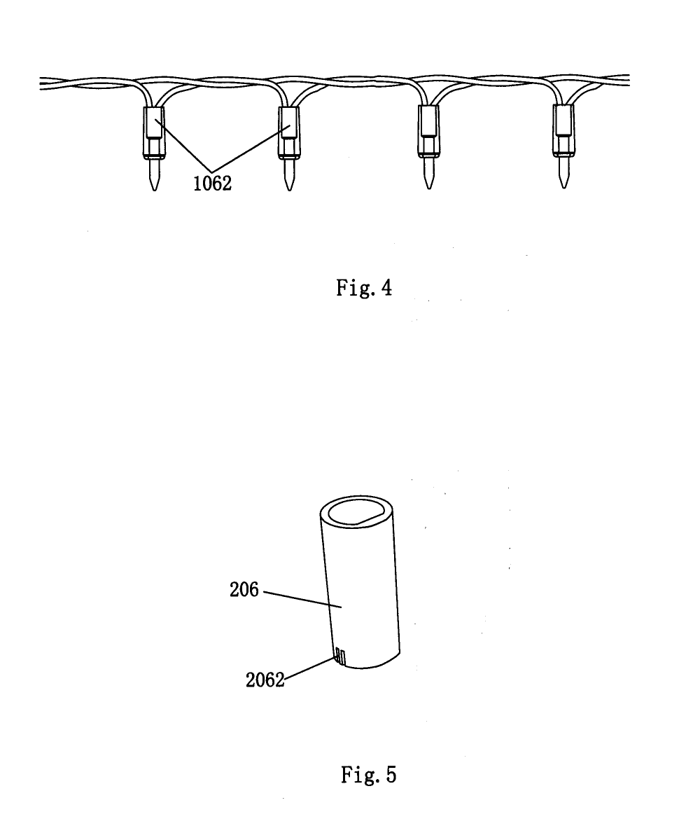

When using the LED lamp holder of the invention, dispose the planes 1062 on the outside of soft heads 106 to the same direction just according to the way shown as FIG. 4, which can enable LED lamp polarities of the whole LED lamp string to coincide with one another.

FIG. 5 shows a perspective view of a soft head, in accordance with the second example embodiment. It differs from the first example embodiment that the soft head 206 has two cuts 2062 on the location of one end thereof into which a wire of anode is inserted to mark the polarity of a LED lamp in the second example embodiment.

What is claimed is:

1. A LED lamp holder, comprising:
a soft head, which has a columnar shape and is made of insulated materials;
a stopper-shaped soft core, which is made of insulated materials and pre-assembled with a LED bulb having a long polarity and a short polarity; and
two connecting plates disposed on ends of two wires, wherein the soft core and the connecting plates are inserted into each other respectively from two ends of the soft head and mounted in the soft head, and two polarities of a LED bulb connect with two connecting plates respectively; wherein
the soft core has a high polarity-fixing portion and a low polarity-fixing portion on the end thereof which joins with the connecting plates, the long polarity of LED lamp fixed on the high polarity-fixing portion, and the short polarity of LED lamp fixed on the low polarity-fixing portion; the soft core has a first plane on an outside surface thereof and the soft head has a second plane on an inside surface thereof which corresponds to the first plane of the soft core to limit the circumferential location of the soft core in the soft head; a polarity-distinguishing device is formed on the outside of the soft head.

2. The LED lamp holder of claim 1, wherein the fitting surface between the soft core and the soft head is a columnar surface, and the first plane and the second plane are respectively formed on the columnar surface of the soft core and the columnar surface of the soft head, both which are parallel with the axis of the columnar surface.

3. The LED lamp holder of claim 1, wherein the polarity-fixing portion has a slot thereon for fixing the polarity.

4. The LED lamp holder of claim 1, wherein the polarity-distinguishing device is a plane on the surface of the soft head, and two connecting plates are respectively disposed to the right and the left of the plane.

5. The LED lamp holder of claim 1, wherein the polarity-distinguishing device is two cuts on the location of one end of the soft head in which a wire is inserted.
